(19) United States
(12) Patent Application Publication
(10) Pub. No.: US 2013/0132209 A1
(43) Pub. Date: May 23, 2013

(54) GENERATING AN ADVERTISING CAMPAIGN

(71) Applicants: Srikanth Belwadi, Bangalore (IN); Vineet Gupta, Palo Alto, CA (US); Michael Rosett, Sherman Oaks, CA (US); Pranav Tiwari, Bangalore (IN); Jagannathan Laxmi Narasimhan, Bangalore (IN); Sumit Sanghai, Bangalore (IN); Dustin Jackson, Long Beach, CA (US)

(72) Inventors: Srikanth Belwadi, Bangalore (IN); Vineet Gupta, Palo Alto, CA (US); Michael Rosett, Sherman Oaks, CA (US); Pranav Tiwari, Bangalore (IN); Jagannathan Laxmi Narasimhan, Bangalore (IN); Sumit Sanghai, Bangalore (IN); Dustin Jackson, Long Beach, CA (US)

(73) Assignee: GOOGLE INC., Mountain View, CA (US)

(21) Appl. No.: 13/294,827

(22) Filed: Nov. 11, 2011

(51) Int. Cl. G06Q 30/02

(52) U.S. Cl. 705/14.72

(57) ABSTRACT

A system and method for automatically generating an online advertising campaign is disclosed. A campaign building engine receives an advertiser's landing page and determines a set of key terms. From the key terms, the campaign building engine determines classifications for potential advertising structures. The campaign building engine then generates proposed advertising structures by assigning each key word to one of the classifications. The proposed advertisings structures can then be presented to a user for selection of advertising structures of the advertising campaign.

### FIELD

The present disclosure generally relates to on-line advertising and, more particularly, to automatically generating an advertising campaign.

### BACKGROUND

This section provides background information related to the present disclosure.

On-line advertising has become an effective means to target potential consumers. One form of on-line advertising is advertising on search engines using key terms. A key term is a phrase including one more words or strings of characters that a user of a search engine may include in a query for a particular topic. An advertiser can direct Internet traffic to one or more web pages called landing pages. The advertiser can provide a list of key terms that the advertiser believes a potential customer would enter when looking for a web page that contains subject matter similar to the landing page. For instance, a purveyor of hiking boots could provide a list of key terms to a search engine that includes “hiking boots,” “hiking shoes,” “trail shoes,” and “outdoor gear” such that when a search engine user executes a search using the search term “hiking shoes” an advertisement containing a hyperlink to the landing page of the advertiser is presented to the user. The process of building advertising campaigns can be time consuming.

### SUMMARY

This section provides a general summary of the disclosure, and is not a comprehensive disclosure of its full scope or all of its features.

In various embodiments of the present disclosure, a computer-implemented method for generating an on-line advertising campaign for a web location is disclosed. The on-line advertising campaign includes at least one advertising structure. The method includes receiving, by one or more processors, a digital document containing text and determining, by the one or more processors, a plurality of key terms from the text. The method further includes determining, by the one or more processors, a classification based on the plurality of key terms and determining, by the one or more processors, a correspondence between each of the key terms and the classification. The method further includes associating, by the one or more processors, a subset of the plurality of key terms with the classification based on the correspondence between each of the key terms of the plurality of key terms and the classification, and generating, by the one or more processors, an advertising structure based on the subset of key terms and the web location. The method further includes providing, by the one or more processors, the advertising structure for display at a user terminal.

In various embodiments of the present disclosures, a campaign building engine for generating an on-line advertising campaign for a web location is disclosed. The campaign building engine includes one or more processors and a computer readable medium storing instructions for generating the on-line advertising campaign. The instructions are executable by the one or more processors. The campaign building engine includes a document retrieving module that retrieves a digital document containing text, the digital document corresponding to the web location, and a key term determination module that determines a plurality of key terms from the text. The campaign building engine also includes a classification module that determines a classification based on the plurality of key terms. The campaign building engine further includes an advertising structure generation module that: i) determines a correspondence between each of the key terms and the classification, ii) associates a subset of the plurality of key terms with the classification based on the correspondence between each of the key terms of the plurality of key terms and the classification, and iii) generates an advertising structure based on the subset of key terms and the web location. The campaign building engine further includes a user interface that provides the advertising structure for display at a user terminal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a drawing illustrating an example of a screen shot of a search performed on search engine;

FIG. 2 is a drawing illustrating an example of an environment of a campaign building engine;

FIG. 3 is a block diagram illustrating an example of components of a campaign building engine;

FIG. 4 is a drawing illustrating an example of an on-line advertising campaign;

FIG. 5 is a block diagram illustrating an example of components of a key term determination module;

FIG. 6 is a block diagram illustrating an example of components of a grouping module;

FIG. 7 is a flow chart illustrating an example of a method for determining potential classifications for advertising structures;

FIG. 8 is a flow chart illustrating an example of a method for assigning key terms to classifications;

FIG. 9 is a drawing illustrating an example of a hierarchy of a retail website;

FIG. 10 is a drawing illustrating an example of a set of proposed advertising structures; and

FIG. 11 is a drawing illustrating an example of a set of proposed advertising structures and proposed additional landing sites.

Corresponding reference numerals indicate corresponding parts throughout the several views of the drawings.

### DETAILED DESCRIPTION

Example embodiments will now be described more fully with reference to the accompanying drawings.

As consumers continue to turn to online retailers to fill their shopping needs, consumers are increasingly relying on search engines to find retailer options. Typically, a search engine receives a search query comprised of one or more words from a user and will provide search results including hyperlinks to potential retailers based on the received search query. The search results, however, may also include hyperlinks to informational pages, news articles, message boards, or any other web pages containing the words in the search query. A search engine can be configured to provide directed advertisements in the search results so that the consumer is able to quickly find a hyperlink to a retailer, rather than having to sift through superfluous search results.

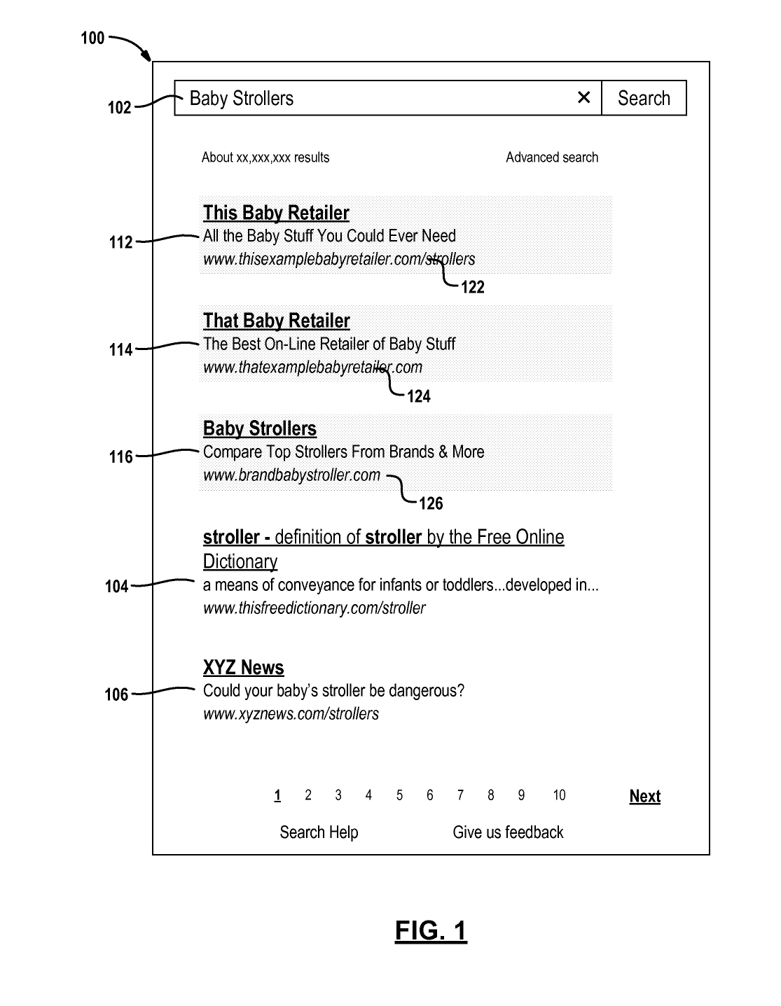

FIG. 1 illustrates an example of a screen 100 that is displayed to a search engine user by a user interface of a search engine. In this example, a user has entered the search query “baby strollers” in a search query field 102. The search results 104 and 106 are displayed at the bottom portion of the screen 100. Above the search results 104 and 106 are a first advertisement creative 112, a second advertisement creative 114 and a third advertisement creative 116. The advertisement creatives 112, 114 and 116 are retrieved by the search engine based on the received search query. The advertisement creatives 112, 114 and 116 contain hyperlinks 122, 124, and 126 that link to the retailers' respective web pages. The user can click on a hyperlink 122, 124, and 126 in one of the advertisement creatives 110, 112, and 114 to be directed to a web page of the advertiser. The web page to which the user is directed to is sometimes referred to as a “landing page.”

As can be appreciated, the foregoing framework for advertising a web page is efficient as the advertisement creatives 112, 114 and 116 are presented to a user based on the search query entered by a user, i.e., a potential consumer. An advertiser utilizes advertising campaigns that are designed to attract potential consumers to the advertiser's web page. An advertising campaign may include one or more advertising structures. An advertising structure is a unit of the advertising campaign, which can include, for example, a set of key terms that can be conceptually related to the content of the advertiser's landing page. Each key term can include of one or more words or strings or characteristics such that when a search engine user enters a search query containing the key term, an advertising creative 112, 114 and 116 corresponding to the landing page can be displayed to the user. Thus, a key term can be thought of as a hypothetical search query that a user may provide to a search engine when searching for a particular subject matter or web page.

To build advertising campaigns, advertisers can determine a list of key terms to associate with their landing pages, e.g., potential search queries that a user may enter to find the advertiser's landing page, and can create advertising structures based on the list of key terms. As the efficacy of online advertising campaigns is becoming increasingly validated, the use of advertising campaigns is becoming more widespread. Systems and methods for automatically building online advertising campaigns consistent with this disclosure can be used, for example, to reduce the amount of time needed to build comprehensive advertising campaigns for one or more landing pages.

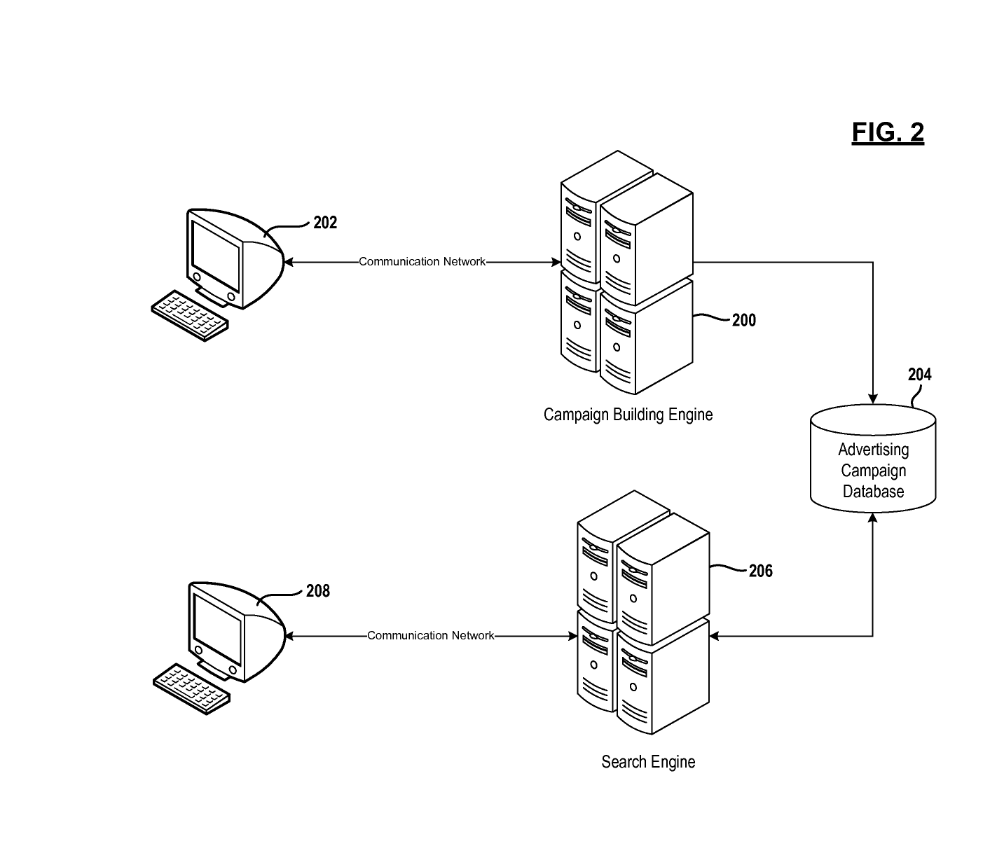

FIG. 2 illustrates an example of an environment for automatically generating advertising campaigns for advertisers. The environment includes a process such as a campaign building engine 200 that communicates with one or more user terminals 202 over a communications network. A user terminal 202 can be any type of computing device, including but not limited to, a computer, a laptop computer, a smart phone, a mobile telephone, a PDA, a tablet PC, or any other device operable to communicate with the campaign building engine 200. A user can provide the campaign building engine 200 with a digital document or a network address of the digital document, and the campaign building engine 200 can generate a proposed advertising campaign based on the digital document. In some embodiments, the digital document is a landing page to which the advertising campaign is directed. It is appreciated that while the user can provide a desired landing page or a URL thereto, the user can provide a different web page as well.

The campaign building engine 200 can analyze the text contained in the web page and generate one or more proposed advertising structures to the user via the user terminal 202. Each proposed advertising structure can include a set of key terms that relate to a classification of the advertising structure, which is described further below. The user can select one or more of the proposed advertising structures to be included in the advertiser's advertising campaign.

The selected advertising campaign can be stored in an advertising campaign database 204 associated with a search engine 206. The advertising campaign database 204 can store the advertising campaign, the advertising campaign including the advertising structures containing key terms, the address of the landing page or pages to which the advertising campaign is directed to, and advertising creatives associated with the advertising campaign. Thus, when a search engine user accesses the search engine 206 from a user terminal 208 and enters a search query containing one or more of the key terms contained in an advertising campaign, the search engine 206 can query the advertising campaign database 204 with the entered search query to receive the advertising creative associated with the search query. The search engine 206 can then display one or more advertising creatives 112, 114, and 116 (FIG. 1) corresponding to the entered search query to the user, in addition to the search results 104 and 106.

The foregoing environment for the campaign building engine 200 is an example, and variations thereof are contemplated. For instance, in some environments the campaign building engine 200 can execute on the user terminal 202 as an offline or an online tool. In other environments, the campaign building engine 200 may be unaffiliated with the search engine 206, such that the user manually provides the advertising campaign or advertising campaigns to one or more advertising campaign databases 204 of one or more search engines 206. Furthermore, the advertising campaign can be implemented as an API to suggest advertising structures to a user given a URL.

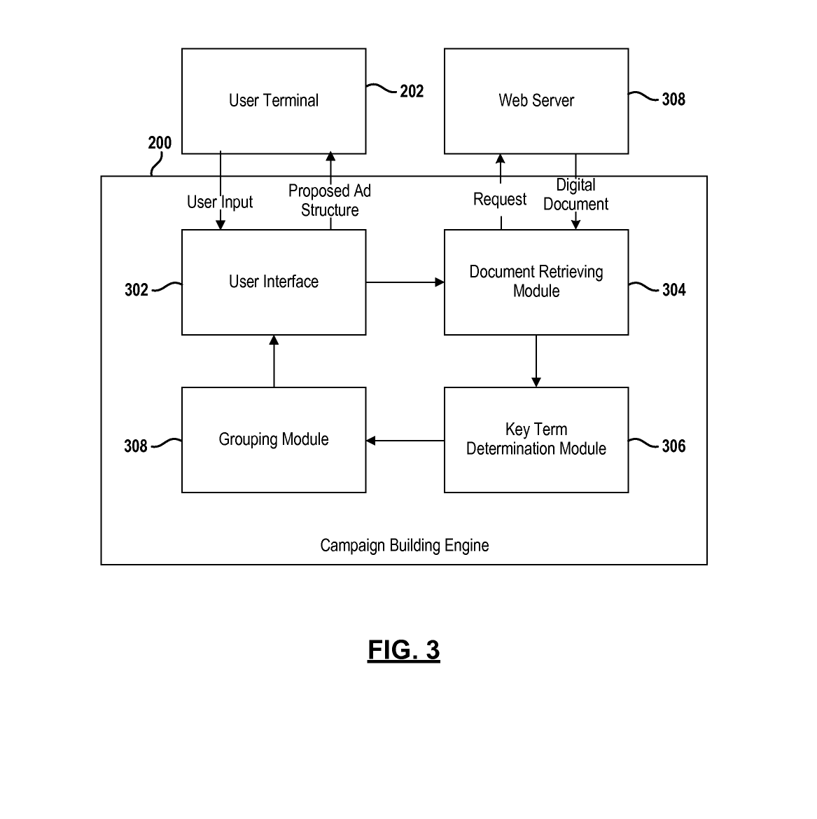

FIG. 3 illustrates an example embodiment of the campaign building engine 200. The campaign building engine 200 can include a user interface 302, a document retrieving module 304, a key term determination module 306, and a grouping module 308. The foregoing components are provided as an example and the campaign building engine 200 may include additional or alternative components.

The user interface 302 provides an interface for a user, e.g., potential advertiser, to interact with the campaign building engine 200. The user interface 302 can present a screen or multiple screens that allow the user to provide a digital document or a network address of a web page. For instance, the user interface 302 can display a field that allows the user to enter the URL of a desired landing page. The user interface can also display a field that allows the user to upload the actual landing page, e.g., the HTML document containing the content of the landing page, from the user terminal 202. For purposes of explanation, the campaign building engine 200 will be described as receiving the network address of the landing page, though it will be understood that other approaches may be envisioned.

The document retrieving module 304 is configured to retrieve the digital document, e.g., the landing page, from a network location through a web server 310. In some embodiments, the document retrieving module 304 receives a location of the landing page via the user interface 302, requests the landing page from a web server 310 hosting the landing page, and retrieves a copy of the landing page from the web server 310. The document retrieving module 304 may be further configured to retrieve web pages that link to or from the landing page, or web pages that are otherwise related to the landing page.

The key term determination module 306 receives one or more digital documents, e.g., landing pages, from the document retrieving module 304 and determines key terms corresponding to the digital documents. As will be discussed below, the key term determination module 306 parses the text contained in the digital documents, and analyzes the parsed text to identify potential search queries that would lead a search engine to the digital document. In some embodiments, the key term determination module 306 can receive a landing page from the document retrieving module 304 and determine a set of search queries that may be provided to a search engine during a search intended to find the landing page or a similar web page. The search queries that the key term determination module 306 identifies can be defined as key terms.

For example, a user affiliated with an online baby goods store can provide a link to the baby stroller home page, i.e., the web page that provides the links to different makes and models of strollers. The key term determination module 306 analyzes the text contained in the home page and determines a set of search queries that a potential buyer would enter into a search engine, if searching for a baby stroller retail site. In the example provided above, the key term determination module 306 may extract the key terms: “stroller,” “baby stroller,” “umbrella stroller,” and “double stroller,” from the provided landing page. The key term determination module 306 may also analyze the text of pages that link to and/or from the landing page to enhance the set of key terms.

In some embodiments, the key term determination module 306 can further expand the set of key terms beyond the key terms identified in the landing page and/or the related pages. For example, if a page contains the term “baby stroller,” the key term determination module 306 can expand the list of key terms to include “baby buggy” and “baby pram,” despite the terms not appearing in the landing page or in a related page. As will be discussed below, the key term determination module 306 can use various techniques to expand the set of identified key terms.

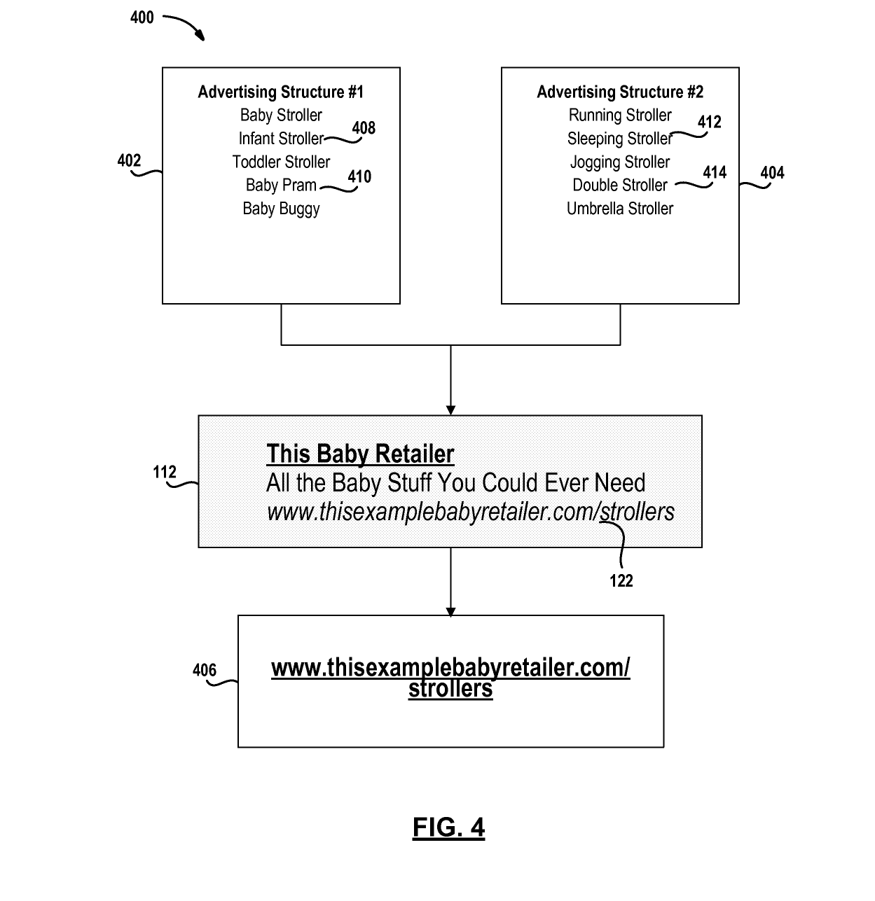

The grouping module 308 receives a list of key terms from the key term determination module 306 and determines one or more proposed advertising structures based on the key terms. As discussed, an advertising structure is a structure containing a group of key terms that correspond to an advertisement or a landing page. FIG. 4 illustrates an example of an advertising campaign 400 comprised of two advertising structures 402 and 404. In the example, both advertising structures 402 and 404 contain key terms 408, 410, 412, and 414 relating to strollers. The first advertising structure 402 contains key terms 408 and 410 that correspond to the “baby stroller.” The second advertising structure 404 contains key terms 412 and 414 that correspond to “running strollers.” Further, both advertising structures 402 and 404 are associated to an advertising creative 112, whereby when one or more of the key terms are entered in a search query, the associated advertising creative 112 may be displayed to the searcher. The advertising creative 112 contains a hyperlink to the landing page 406, e.g., “www.thisexamplebabyretailer.com/strollers.” It is appreciated that the advertising structures provided in FIG. 4 are merely provided for example. The amount of advertising structures corresponding to a creative or landing page can vary, as can the amount of key terms in an advertising structure.

Referring back to FIG. 3, the grouping module 308 receives the key terms from the key term determination module 306 and determines classifications for the advertising structures. A classification is a concept that one or more of the key terms may be associated with for the purposes of generating a potential advertising structure. The classifications can be determined from the key terms identified by the key term determination module 306. As will be discussed, the grouping module 308 treats the key terms as potential classifications, and selects one or more of the key terms as classifications for the advertising structures. The grouping module 308 can determine the classifications in a number of ways. In some embodiments an inverse document frequency (“IDF”) score of a key term is used to determine whether the key term is an appropriate classification. In some embodiments, the grouping module 308 will further create classifications containing templates having tags for trade names, locations, or industry verticals as classifications. An example of a classification containing a template is “Hotels in #LocationName,” such that any key term having a “hotel in” and a geographic location name would exact match to “Hotels in #LocationName.” It is appreciated that other means for determining a classification are also considered and will be discussed below.

Once the grouping module 308 has selected one or more classifications, the grouping module 308 associates the key terms to the different classifications. For example, the grouping module 308 may associate a key term to a classification if one or more words of the key term matches to one or more of the words in the classification. Once each key term has been associated to all applicable classifications, the grouping module 308 can determine to which classification a key term is assigned based on an affinity score of the classification with respect to the key terms associated thereto. To the extent a key term is associated to more than one classification, the key term can be assigned to the classification that has the highest affinity score. The calculation of an affinity score of a classification is described in greater detail below. The grouping module 308 can then divide or remove any classifications that have too many key terms assigned thereto, or can merge classifications that do not have a requisite amount of key terms associated thereto.

It is noted that a resulting classification and the key terms assigned thereto are a potential advertising structure. The campaign building engine 200 can present the resulting potential advertising structures to the user via the user interface 302. The user can then select one or more of the potential advertising structures as a part of the online advertising campaign. As will be discussed below, the campaign building engine 200 can also be configured to determine potential advertising campaigns for related web pages.

An example of the campaign building engine 200 will now be described in greater detail. It is appreciated that following is provided for example and is not intended to be limiting, as variations of the campaign building engine 200 are contemplated.

As discussed, the campaign building engine 200 receives a digital document or an address thereof. For explanatory purposes, it is assumed that the user provides a network address of a desired landing page. In an example embodiment, the user provides the URL of the landing page via the user interface 302. For example, the user may enter “www.thisexamplebabyretailer.com/strollers” as the URL. The user interface 302 communicates the URL to the document retrieving module 304.

The document retrieving module 304 is configured to retrieve the landing page of the provided URL from a web server 310. It is appreciated that any known technique for retrieving the document can be implemented by the document retrieving module 304. In some embodiments, the document retrieving module 304 may also retrieve web pages that are related to the landing page. In these embodiments, the document retrieving module 304 can analyze the landing page to determine if there are any hyperlinks embedded in the landing page or any pages that hyperlink to the landing page. If there are hyperlinks embedded in the landing page or pages which hyperlink to the landing page, the document retrieving module 304 can retrieve those web pages as well. It is appreciated that the document retrieving module 304 can also retrieve pages that are related but not linked to the landing page. For example, the website “www.thisexamplebabyretailer.com/toys” may not be linked to “www.thisexamplebabyretailer.com/strollers.” Nonetheless, the document retrieving module 304 can be configured to retrieve the “toys” page because of the common domain name, i.e., “www.thisexamplebabyretailer.com.” It is appreciated that the document retrieving module 304 can be further configured to filter out certain web pages that are of limited utility to building an advertising campaign, such as FAQ pages, “contact us,” and other non substantive pages.

Once the document retrieving module 304 has retrieved the landing page and any related pages, the document retrieving module 304 provides the landing page and related pages to the key term determination module 306. The key term determination module 306 receives one or more web pages and determines a list of key terms corresponding to the web pages. A key term is comprised of one or more words that could be included in a hypothetical search query that a searcher could use if trying to find the web page being analyzed.

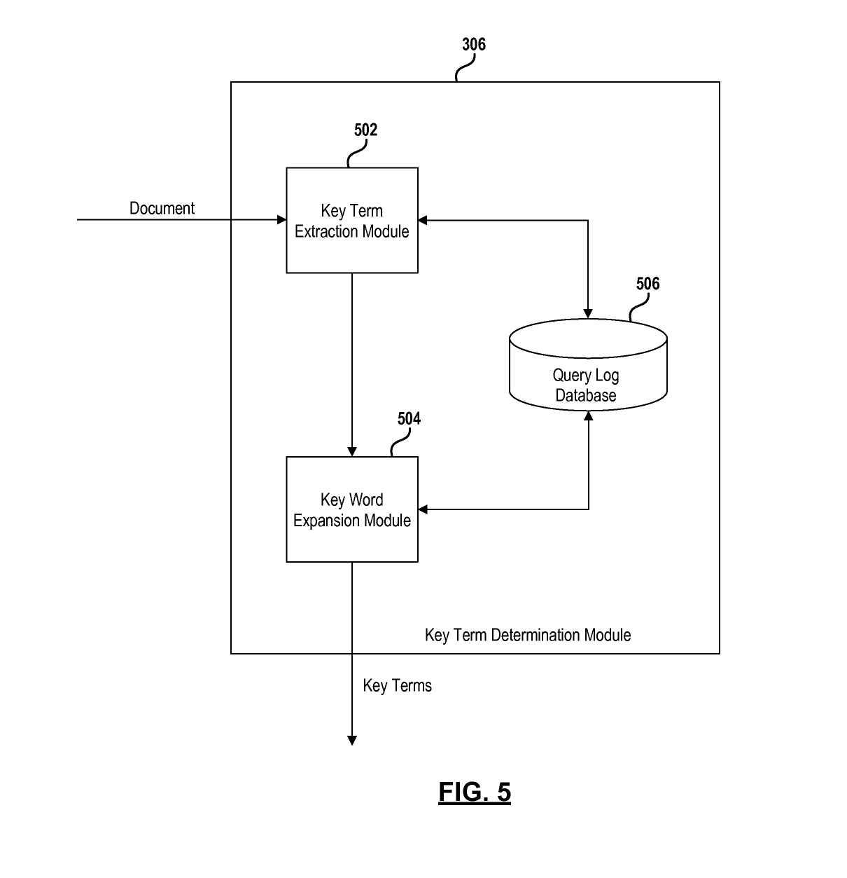

FIG. 5 illustrates an example of a key term determination module 306. The key term determination module 306 can include a key term extraction module 502 and a key term expansion module 504. Further, the key term determination module 306 may include a query log database 506.

It is noted that the query log database 506 may be a component of the campaign building engine 200 or may be located at a different location or server. In these embodiments, the key term determination module 306 may access the query log database 506 via a network, such as an intranet or the Internet. The query log database 506 is a database that stores a representative sampling of search queries provided to one or more search engines 206, as well as web pages that have been accessed as a result of the search query. It is noted that the query log database 506 may only include results of commercial searches, and may exclude private or non-commercial search queries and results, thereby protecting the privacy of a user. Further, a query log database 506 can also store search queries anonymously, to further protect the privacy of a user.

The key term extraction module 502 receives a web page, e.g., the landing page, and extracts potential key terms therefrom. As mentioned earlier, the key terms are one or more terms that a hypothetical searcher may provide to a search engine 206 to find the web page being analyzed. The key term extraction module 502 can extract key terms from the received web page or pages in any suitable fashion. For example, in some embodiments the key term extraction module 502 parses the text of a web page, removes all stop words such as “a,” “an,” “the,” “and” or “or” from the parsed text, and indexes the terms found throughout the document. The key term extraction module 502 can index all strings of words that are less than a total maximum amount of words, for example only, all strings of five words or less. The key term extraction module 502 then queries the query log database 506 to determine which extracted terms are legitimate search queries. Thus, key term extraction module 502 queries the query log database 506 with each extracted string of terms. If a string of terms has been used as a search query in more than a nominal amount of searches, then the string of words is considered a potential key term. If the string of terms has not been used as a search query or has only been used a nominal amount of times as a search query, then the string of words can be disregarded.

Once all the potential key terms have been identified from the extracted terms, the key term extraction module 502 calculates the relevancy score of each potential key term with respect to the web page being analyzed. It is appreciated that any suitable means for determining a relevancy score of a potential search term with respect to the web page can be calculated. For instance, the key term extraction module 502 can determine an amount of times that the potential search term is found throughout the web page, or if the potential search term is found in a title or heading of the web page. For instance, if a web page is directed to BrandZ mp3 players, the term “BrandZ mp3 player” may be found in the title of the page, as well as many times throughout the page. The key term extraction module 502 may calculate a score of 99/100 for the term “BrandZ mp3 player.” The term “mp3 player” may be assigned a score of 90/100. The term “music player” may be found throughout the page, but not in the heading, and would have a lower relevancy score than “BrandZ mp3 player” or “mp3 player,” e.g., 74/100. The term “photo viewer” may be found only once in the web page, and would, therefore, have an even lower relevancy score than “music player,” e.g., 10/100. The relevancy score can be calculated in any other suitable fashion.

The relevancy score of each potential key term can be compared to a relevancy score threshold. For example, the relevancy threshold may be 30/100. If the relevancy score of a potential key term is greater than the relevancy score threshold, the potential key term is included in the key terms. If the score is below the relevancy score threshold, the potential key term is disregarded. It is appreciated that the relevancy score threshold can be set by a developer or a user, or can be learned by the campaign building engine.

As mentioned, the key term determination module 306 may further include a key term expansion module 504. The key term expansion module 504 receives the extracted key terms from the key term extraction module 502, and determines any additional search queries that are similar to the extracted key terms. For example, if the key term extraction module 502 extracted the term “baby stroller” from the landing page, the key term extraction module 502 provides key terms that are similar to the “baby stroller,” e.g., “baby pram,” “baby buggy,” “infant stroller,” and “toddler stroller.” The key term expansion module 504 can expand the extracted key terms in any suitable fashion. For example, the key term expansion module 504 can query the query log database 506 with an extracted key term and receive other search queries that searchers have used to find the same pages. For example, if there are high frequencies of search engine users entering the search queries “baby stroller” and “infant stroller” to find the same retailer web pages, the query log database 506 will return “infant stroller” in response to a request for similar search queries to “baby stroller.”

It is envisioned that other suitable means for expanding the set of extracted key terms can be employed instead of or in addition to that described above. For example, in some embodiments the key term expansion module 504 can substitute synonyms for terms. In some embodiments, the key term expansion module 504 can substitute trade names found in key terms with other key terms, e.g., the key term “BrandZ mp3 player” can be substituted with “BrandX mp3 player” or “BrandY mp3 player.”

It is appreciated that the key term determination module 306 can operate in any suitable fashion. Further, while the key term determination module 306 can be configured to receive one or more web pages and to provide a list of key terms, the key term determination module 306 can receive other forms of input, such as suggested key terms instead of, or in addition, to the web page or pages.

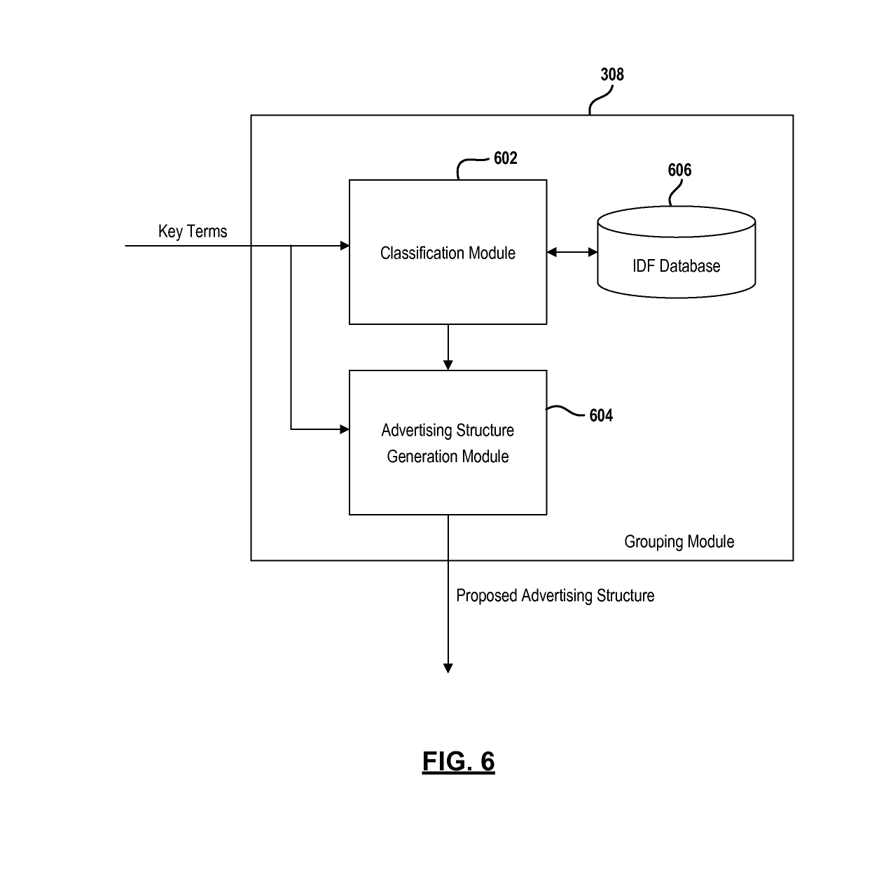

The key term determination module 306 provides a set of key terms to the grouping module 308. The grouping module 308 is configured to generate one or more proposed advertising structures, where each advertising structure contains a plurality of key terms. FIG. 6 illustrates an example of a grouping module 308. The grouping module 308 is comprised of a classification module 602 and an advertising structure generation module 604. In some embodiments, the grouping module 308 may further include an inverse document frequency (“IDF”) database 606 that stores the IDF scores of key terms.

The classification module 602 is configured to receive a set of key terms from the key term determination module 306 and to determine possible classifications for potential advertising structures. The possible classifications can be thought of as concepts or categories for the advertising structures. As will be discussed below, the advertising structure generation module 604 receives the potential classifications and the key terms and associates the key terms to the classifications, thereby generating potential advertising structures.

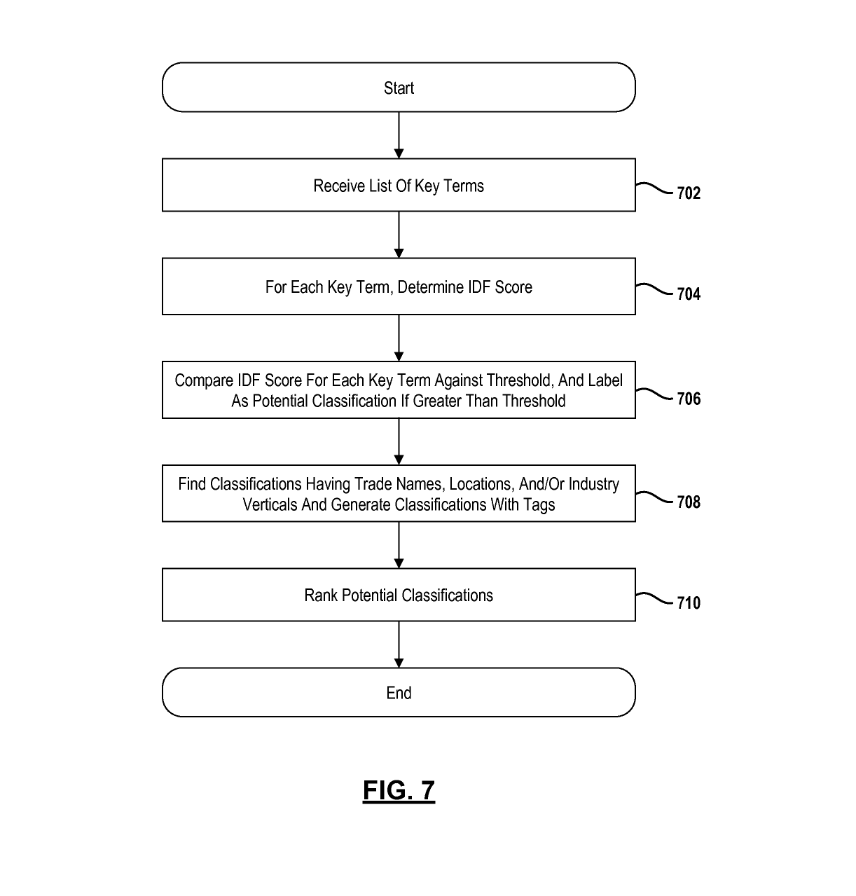

FIG. 7 illustrates an example of a method 700 that can be executed by a process such as the classification module 602. The classification module 602 determines possible classifications for potential advertising structures based on the set of key terms derived from the landing page. For example only, the classification module 602 can determine inverse document frequency (IDF) score of a key term and can label the key term as a classification if the IDF score exceeds an IDF threshold. Thus, as shown at stage 702, the classification module 602 receives the set of key terms from the key term determination module 306. Each key term is an N-gram comprised of 1 or more words, up to a limit. For example, a set of key terms is provided in Table I. In this example, the terms are derived from a landing page for BrandZ mp3 players.

TABLE I

| | | |
|---|---|---|
| BrandZ mp3 player | BrandZ Mini | 32 GB BrandZ Mini |
| 16 GB BrandZ | BrandZ Macro | BrandZ Shuffle |
| BrandZ Classic | 16 GB mp3 player | 16 GB music player |
| . . . | | |

As can be appreciated, the list of key terms may include many more terms than listed in Table I. In the example, the key terms are N-Grams where N is an integer less than or equal to 4.

For each key term, the classification module 602 determines an IDF score for the key term, as shown at stage 704. An IDF score is a statistical measure that indicates how important a particular term is to a particular document. The importance of a term is proportional to the amount of times the term appears in a document, but is offset by the amount of times the term is found in the universe of documents, e.g., all indexed documents found in the Internet. Thus, if a term is found frequently throughout a document but not found frequently throughout the Internet, the term would have a high IDF. For example, the term “South American Kumquat” may be found many times throughout a landing page for a South American fruit importer but not very frequently anywhere else. Thus, with respect to the landing page, “South American Kumquat” would have a very high IDF score. Conversely, the term “digital camera” that appears once in a landing page of a mobile telephone retailer, would have a relatively low IDF score.

An IDF can be calculated in any known fashion. One such formula for calculating an IDF score of a term, T is:

$$IDF ( T ) = F ( {T}_{Doc} ) * log ( \frac{{D}_{Total}}{{D}_{T}} ) ;$$

where F(T_{Doc}) is the amount of times the term T is found in the document Doc, D_{T} is the total amount of documents in the universe of documents that have at least one instance of the term T, and D_{Total} is the total amount of documents in the universe of documents. The classification module 602 can query the IDF database 606 with the term T, to determine the amount of documents in the universe of documents containing the term T. Further, the classification module 602 can obtain the total amount of documents in the universe of documents (D_{Total}) from the IDF database 606. F(T_{Doc}) can be obtained from the landing page. Using the equation provided above, the classification module 602 can calculate the IDF score for each key term. Table II illustrates the key terms provided in the Table I with examples of IDF scores.

TABLE II

| | | |
|---|---|---|
| BrandZ mp3 | BrandZ | 32 GB BrandZ |
| player—3.3 | Mini—3.6 | Mini—3.8 |
| 16 GB | BrandZ | BrandZ |
| BrandZ—3.7 | Macro—3.2 | Player—3.3 |
| BrandZ | 16 GB mp3 | 16 GB music |
| Classic—3.2 | player—2.1 | player—0 |
| . . . | | |

As can be seen from Table II, 32 GB BrandZ Mini has the highest IDF score, 3.8, and the key terms with the term “music player” have scores of 0, as the term music player may not have appeared in the original document. The classification module 602 compares the IDF score of each key term against an IDF threshold, as shown at stage 706. If the IDF score of a key term is above the IDF threshold, e.g., 3.0, then the key term is considered a potential classification. If the IDF score of a key term does not exceed the IDF threshold, then the key term is not considered a potential classification, but remains in the list of key terms. It is appreciated that the IDF threshold can be set by a developer or a user, or can be learned by the campaign building engine.

In some embodiments, the potential classifications are then analyzed to determine if the classification could serve as a basis for a templated classification. A templated classification is a classification with a tag in place of one or more of the words in the key term. In other words, a tag is a genus, while the word or words being replaced by the tag are a species. As will be described below, the advertising structure generation module 604 may be configured to match key terms to classifications. A templated classification allows a greater amount of terms to be matched to a classification. For instance, there may be classifications for “Hotels in New York” and “Hotels in Cairo,” and additional key words such as “Hotels in Detroit” and “Hotels in Tripoli” which were not considered classifications. A templated classification based on the “Hotels in New York” and “Hotels in Cairo” would be “Hotels in #LocationName” whereby any key term with a location name would broad match thereto, e.g., “Hotels in Detroit.” Similarly, classifications containing trade names or industry verticals can also be templated. For example, “Brother's Brands Ties” can be templated to “#Tradename Ties” and “24-Hour Locksmith” can be templated to “24-Hour #EmergencyServiceType.”

To create the templated classifications, the classification module 602 analyzes each classification to determine if it has any taggable elements, as shown at stage 708. For example, the classification module 602 may use each word in a classification to query one or more databases, e.g., a trade name database (not shown), a locations database (not shown), and an industry vertical database (not shown). If the word is found in one of the databases, a new classification is generated using a tag that corresponds to the database in which the word was found. For example, if a word was found in the location database, the classification module 602 would generate a new classification using a #LocationName tag. It is appreciated that a classification can be tagged with one or more tags to create a templated classification. Further, it is appreciated that templated classifications can be created in any suitable fashion.

In the embodiments where templated classifications are generated, the classification module 602 assigns an IDF score to the templated classification. The classification module 602 can use the IDF score of the classification on which the templated classification is based. For example, if a templated classification “Hotels in #LocationName” is based on a “Hotels in New York” classification, the classification module 602 can use the IDF score of the “Hotels in New York” classification to determine the IDF score of the “Hotels in #LocationName” classification. In some embodiments, the classification can assign a slightly lower or slightly higher IDF score to the templated classification. For instance, if the “Hotels in New York” classification has an IDF score of 1.8, the IDF score of “Hotels in #Location name” can be set to 1.7. Further, if two or more classifications have the same structure, e.g., “Hotels in New York” and “Hotels in Cairo,” the IDF score of the templated classification can be based on the lowest of the IDF scores, the highest of the IDF scores, or an average of the IDF scores.

In some implementations, the classifications module 602 can rank the potential classifications, including the templated classifications, in accordance with their IDF scores, as shown at stage 710. The potential classifications, whether ranked or unranked, can then be provided to the advertising structure generation module 604. Further, although not shown in FIG. 7, it is appreciated that the potential classifications and key terms can be filtered to remove stop words, such as “the,” “an,” “a,” “and,” and “or.” Further, the potential classifications and key terms can be stemmed, such that variations of a word or plural or singular forms of a word are included in the classification or key term.

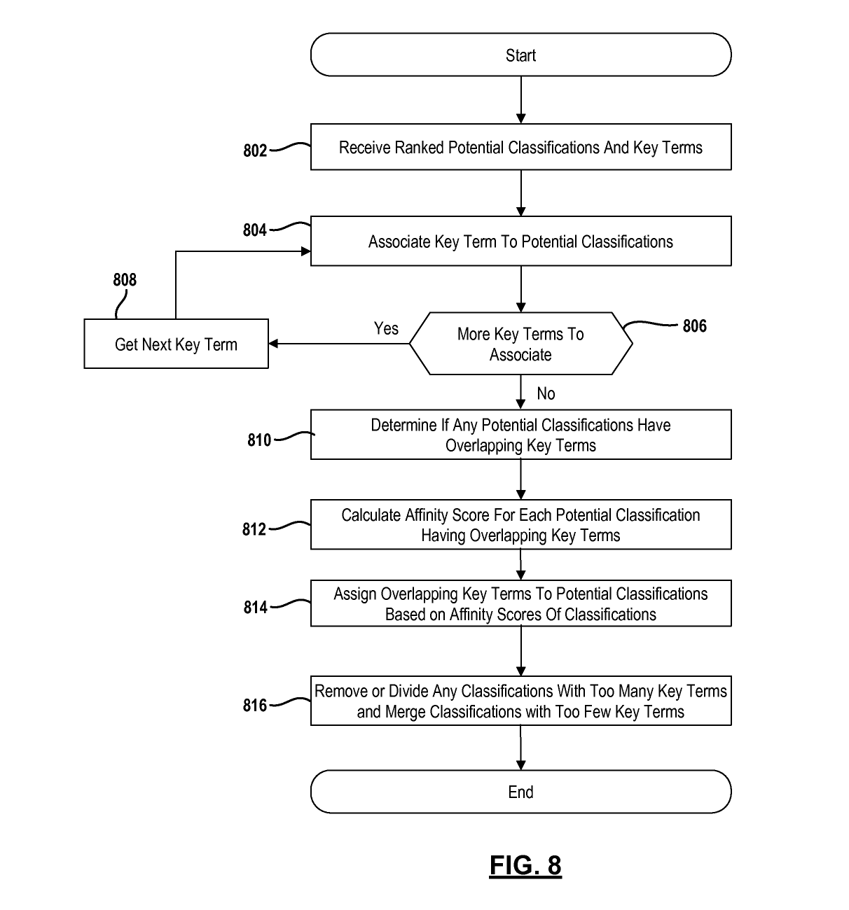

Referring now to FIG. 8, the advertising structure generation module 604 receives the potential classifications and generates one or more proposed advertising structures, which can be presented to a user for inclusion in an advertising campaign. The advertising structure generation module 604 receives the potential classifications and the key terms, as shown at stage 802.

The advertising structure generation module 604 associates the key terms to potential classifications, as shown at stage 804. In some embodiments, the advertising structure generation module 604 associates a key term to a classification when the key term matches to the classification. It is appreciated that any suitable means for matching key terms to classifications can be used. For example, the advertising structure generation module 604 can be configured to associate a key term to any potential classification that the key term broad matches to. Broad matching is when at least one word, or a variation of the word, in the key term matches to at least one word, or a variation thereof, in the classification. For example, a key term of “32 GB” may broad match to “32 GB BrandZ Mini” and “32 GB BrandZ.” In this example, the advertising structure generation module 604 would associate “32 GB” to both the “32 GB BrandZ Mini” classification and “32 GB BrandZ” classification. It is noted that a key term may also broadly match to a templated classification. For example, the term “Mumbai Accommodations” broad matches to “Hotels in #LocationName,” as “Mumbai” matches to #LocationName.

It is appreciated that the advertising structure generation module 604 can associate a key term to as many potential classifications as the key term matches to. Alternatively, in some implementations, the advertising structure generation module 604 can associate the key word to the first N potential classifications that the key word matches to. In these implementations, the advertising structure generation module 604 may be configured to match a key word to the potential classifications in an order that is in accordance with the rankings of the potential classifications.

The advertising structure generation module 604 can match each key term to the potential classifications, until all the key terms have been associated to one or more classifications, as shown in the loop comprising stages 804, 806, and 808. If a key term does not match to any classifications, the key term can be disregarded and discarded.

Typically, many classifications will have overlapping key terms. As can be appreciated, based on the type of matching algorithm that is used to associate the key terms to classifications, a key term may be associated to many classifications. Thus, in some embodiments, the advertising structure generation module 604 can be configured to resolve this issue by removing the overlapping key terms from one or more of the classifications, such that the advertising structure generation module 604 assigns a key term to only one classification. Thus, after the key terms have been associated to the classifications, the advertising structure generation module 604 determines if any of the classifications have overlapping key terms, as shown at stage 810. It is noted that a key term that is associated to only one classification is assigned to that classification.

Once it is determined that there are overlapping key terms, the advertising structure generation module 604 calculates the affinity score of the classification with respect to the key terms contained therein, as shown at stage 812. The affinity score of a classification can be calculated in any suitable fashion. In some implementations, the affinity score of the ith classification Cᵢ, can be calculated using the following formula:

$$Affinity\_Score ( {C}_{i} ) = IDF ( {C}_{i} ) \times \frac{1}{\# \_of \_KeyTerms \_in {\_C}_{i}} ;$$

where #_of_KeyTerms_in_Cᵢ is equal to the number of key terms that are associated to the ith classification Cᵢ including all overlapping key terms, and IDF(Cᵢ) is the IDF score of the ith Classification. It is appreciated that the affinity score of a classification can be calculated in any other suitable fashion. It is appreciated that affinity scores can be calculated for all of the classifications, or only for classifications having overlapping key terms.

After the advertising structure generation module 604 has calculated the affinity scores for the classifications, the overlapping key terms can be assigned to a classification based on the affinity score of the classification, as shown at stage 814. For example, in some embodiments, an overlapping key term will be assigned to classification having the highest affinity score. Once the overlapping key words have been resolved, the classification and the key terms assigned thereto can be assigned to an advertising structure. It is noted that the classification itself can be included as a key term of the advertising structure, as the classification was originated from the list of key words.

Once the key terms have been assigned to the classifications and the advertising structures have been generated, the advertising structure generation module 604 can remove or subdivide any advertising structures that have too many key terms assigned thereto. Similarly, the advertising structure generation module 604 can merge any advertising structures that have too few key terms assigned thereto, as shown at stage 816. The foregoing can be achieved by comparing the amount of key terms assigned to an advertising structure to a maximum key term threshold and a minimum key term threshold. If the amount of key terms assigned to the advertising structure exceeds the maximum key term threshold, the advertising structure is deleted or divided into two or more advertising structures. For example, if eighty key terms are assigned to a single advertising structure, the advertising structure generation module 604 can divide the key terms into two proposed advertising structures of forty key terms each.

If the amount of key terms associated to an advertising structure is below the minimum key term threshold, the key terms of the advertising structure can be merged with the key terms of one or more other advertising structures. For instance, if five key terms are assigned to a first advertising structure, and four key terms are assigned to a second advertising structure, and the minimum key term threshold is seven, the advertising structure generation module 604 can merge the two advertising structures and their key terms into a single proposed advertising structure.

The foregoing stage is optional, as proposed advertising structures of any size could be presented to a user. The maximum key term threshold and the minimum key term threshold can be set by a developer or a user, or can be learned by the campaign building engine. For instance, a maximum key term threshold can be set to 75 key terms and a minimum key term threshold can be set to five or ten key terms.

The method of FIG. 8 is provided for example not intended to be limiting. It is appreciated that the ordering of the stages is not mandatory and not all stages are required. Further, some stages can be combined into one step, while other stages can be performed in multiple steps.

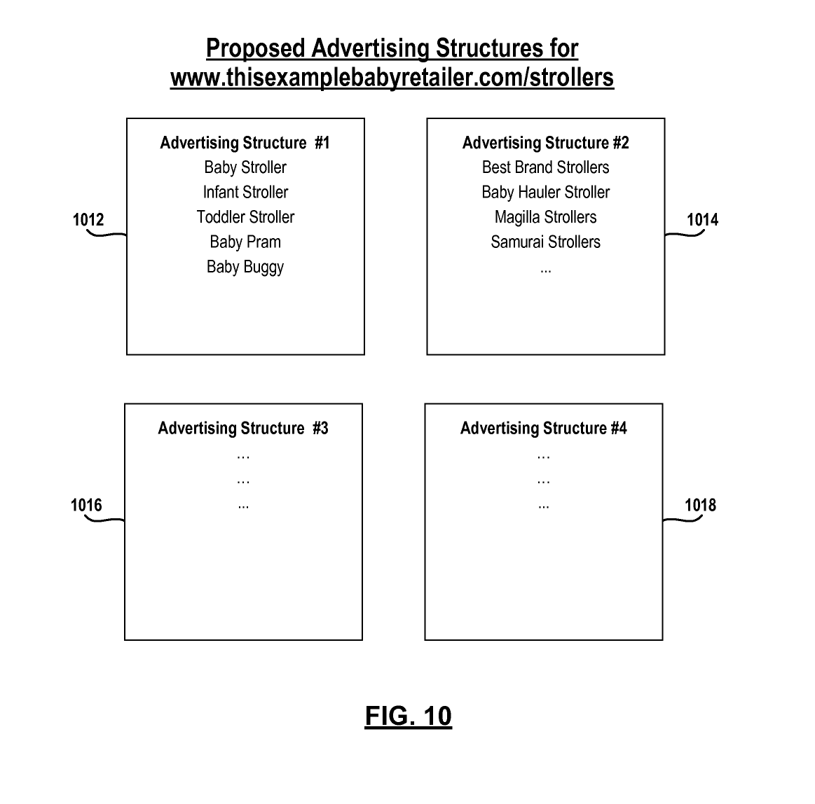

Once the grouping module 308 has generated one or more proposed advertising structures, the grouping module 308 can present the proposed advertising structures to the user via the user interface 302. FIG. 10 illustrates an example of a set of proposed advertising structures 1012, 1014, 1016, and 1018 for a landing page. In the example provided, the user interface 302 is presenting a first advertising structure 1012, a second advertising structure 1014, a third advertising structure 1016, and a fourth advertising structure 1018 for the landing page “www.thisexamplebabyretailer.com/strollers.” The user can then select one or more advertising structures for inclusion in an online advertising campaign. Further, the user can remove or add key terms to a selected advertising campaign. Once the user has selected the one or more advertising structures, i.e., the advertising campaign, the campaign building engine 200 can store the advertising structures in the advertising campaign database 204 (FIG. 2).

It is noted that the campaign building engine 200 can store the URL of the landing page in the advertising structure. Further, the advertiser can provide one or more advertising creatives 112 (FIG. 4) for an advertising campaign 400 (FIG. 4). Thus, the advertising campaign 400 can contain one or more advertising structures 402 and 404 (FIG. 4). An advertising structure 402 can include a plurality of key terms 408 and 410 and an associated URL to a landing page 406. Further, each advertising structure 402 may include an associated advertising creative 112. It is noted that the URL of the landing page 406 and the advertising creative 112 may be common across the entire advertising campaign 400 or can vary from advertising structure to advertising structure.

As discussed above, when a search engine user provides a search query containing one or more of the key terms in a particular advertising structure 402 (FIG. 4) to a search engine 206 (FIG. 2), the search engine 206 can query the advertising campaign database 204 with the search query and will receive the advertising structure 402 containing the key terms 408 or 410 listed in the search query. The search engine 206 can then display the advertising creative associated to the advertising structure 402 as well as a hyperlink 122 to the URL of the landing page 406 that is associated with the advertising structure 402.

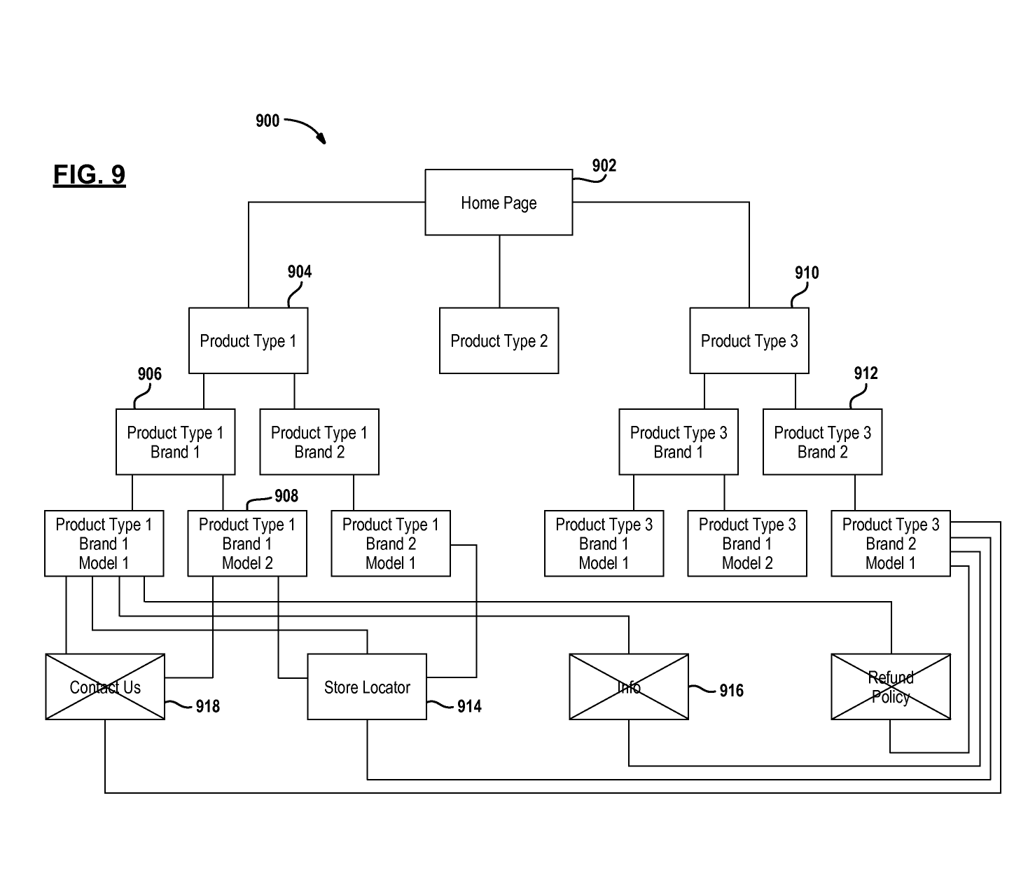

In some embodiments, the campaign building engine 200 can be configured to analyze the entire website of the advertiser to propose advertising campaigns for other potential landing pages found in the website. For example, FIG. 9 illustrates an example of a website 900. The website 900 can include a home page 902 that is found at the URL “www.thisexamplebabyretailer.com.” The website 900 may be a retail site that sells a variety of different products. As such, the website 900 can include products pages 904 and 910 that are directed to particular types of products, e.g., Strollers and Baby Toys. The product pages can have URLs of “www.thisexamplebabyretailer.com/Strollers” and “www.thisexamplebabyretailer.com/Toys.” The website may also include pages directed to particular brands within the products, e.g., page 906 and page 912, as well as models of brands, e.g., page 908. The website 900 can also include traditional pages such as a “contact us” page 918, a “store locator” page 914, and an “info” page 916.

The campaign building engine 200 can be configured to analyze the website 900 to find other potential landing pages and to generate proposed advertising structures for the potential landing pages. As can be appreciated, a user may provide a landing page, e.g., page 904, to the campaign building engine 200. As was described earlier, the document retrieving module 304 can traverse the website 900 to find additional related pages. The document retrieving module 304 can be configured to find pages having the same URL structure as the landing page 904, and label those pages, e.g., page 910, as potential landing pages. The potential landing pages can then be analyzed by the key term determination module 306 and the grouping module 308 in a manner similar to what was described above. The user interface 302 can present the potential landing page and corresponding proposed advertising structures to the user, in addition to displaying the proposed advertising structures for the inputted landing page.

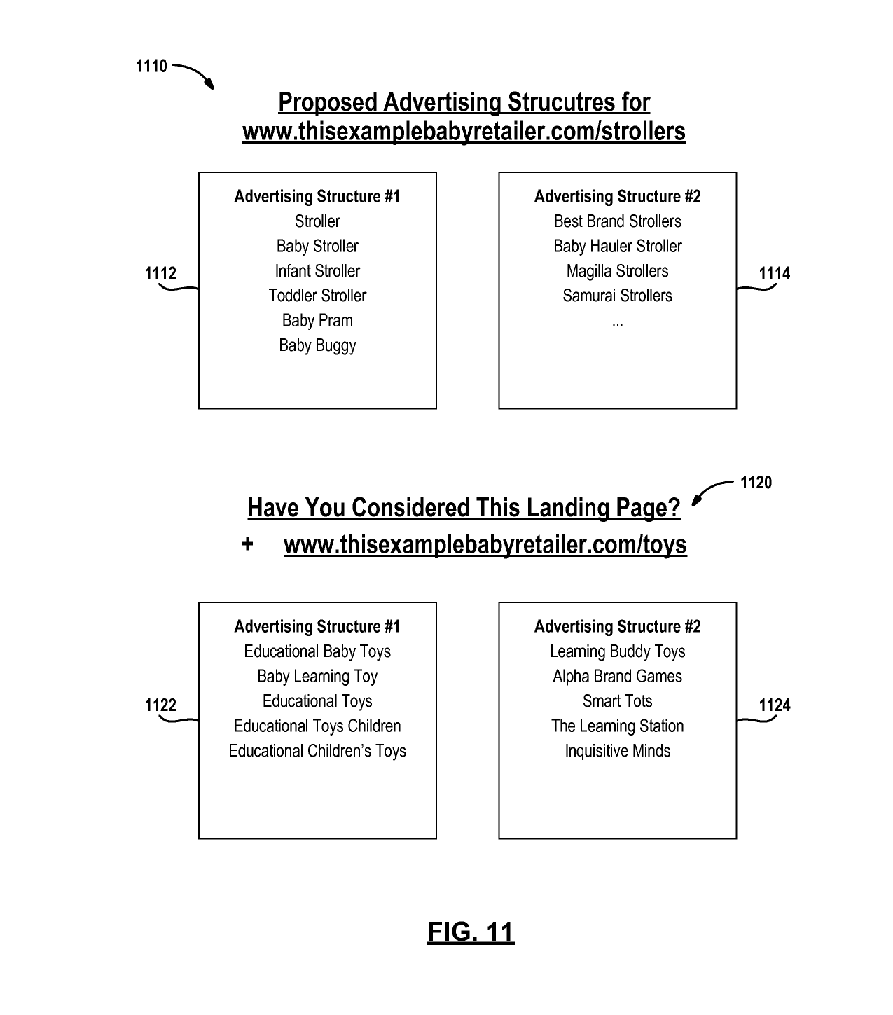

For example, in FIG. 11, the user has provided the URL “www.thisexamplebabyretailer.com/strollers” as the landing page. Using the example provided above, the document retrieving module 304 retrieves the landing page found at “www.thisexamplebabyretailer.com/strollers” and other related pages. One related page may be a potential landing page for educational toys found at the URL “www.thisexamplebabyretailer.com/toys.” The key term determination module 306 and the grouping module 308 can analyze the potential landing page in a manner described above to determine proposed advertising structures 1122 and 1124 for the potential landing page 1120. In addition to the user interface 302 presenting the proposed advertising structures 1112 and 1114 for the inputted landing page, the user interface 302 can present a potential landing page 1120 to the user and the potential advertising structures 1122 and 1124 for the potential landing page 1120. It is appreciated that the campaign building engine 200 can analyze any amount of additional web pages in a website and present any amount of potential landing pages and proposed advertising structures to a user.

The foregoing description of embodiments has been provided for purposes of illustration and description. It is not intended to be exhaustive or to limit the disclosure, and other embodiments are within the scope of the following claims. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative stages may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code, or a process executed by a distributed network of processors and storage in networked clusters or datacenters; other suitable components that provide the described functionality; or a combination of some or all of the above, such as in a system-on-chip. The term module may include memory (shared, dedicated, or group) that stores code executed by the one or more processors.

The term code, as used above, may include software, firmware, bytecode and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

Apparatus and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A computer implemented method for generating an on-line advertising campaign for a web location, the on-line advertising campaign including at least one advertising structure, the method comprising:
receiving, by one or more processors, a digital document containing text;
determining, by the one or more processors, a plurality of key terms from the text;
determining, by the one or more processors, a classification based on the plurality of key terms;
determining, by the one or more processors, a correspondence between each of the key terms and the classification;
associating, by the one or more processors, a subset of the plurality of key terms with the classification based on the correspondence between each of the key terms of the plurality of key terms and the classification; and
generating, by the one or more processors, an advertising structure based on the subset of key terms and the web location;
providing, by the one or more processors, the advertising structure for display at a user terminal.

2. The computer implemented method of claim 1, wherein associating the subset of the plurality of key terms with the classification comprises associating a first key term of the plurality of key terms to the classification when at least one word of the first key term matches at least one word of the classification.

3. The computer implemented method of claim 1, wherein determining the classification comprises determining an inverse document frequency score for each key term of the plurality of key terms and selecting one of the key terms as the classification based on the inverse document frequency scores.

4. The computer implemented method of claim 3, further comprising assigning an overlapping key term to the classification when an affinity score of the classification to the subset of key terms is greater than an other affinity score of an other classification to an other subset of key terms, wherein: 1) an overlapping key term belongs to the subset of key terms and the other subset of key terms, and 2) the affinity score of the classification indicates a measure of correspondence between the classification and the subset of key terms.

5. The computer implemented method of claim 4, wherein the affinity score of the classification is determined based on an amount of key terms in the subset of key terms associated to the classification and the inverse document frequency score of the key term selected as the classification.

6. The computer implemented method of claim 5, further comprising calculating the affinity score of the classification by dividing the inverse document frequency score by the amount of key terms in the subset.

7. The computer implemented method of claim 3, wherein a nonoverlapping key term that belongs to the subset of key terms is assigned to the classification.

8. The computer implemented method of claim 3, further comprising generating a templated classification based on the determined classification, wherein: 1) the templated classification includes a tag substituted for at least one word of the key term selected as the classification is based, and 2) the tag defines a genus of a species of the at least one word being substituted.

9. The computer implemented method of claim 8, wherein a particular key word of the plurality of key words is associated to the templated classification when at least one word of the particular key word is of a species that belongs to the genus of the tag of the templated classification.

10. The computer implemented method of claim 1, wherein determining the plurality key terms comprises parsing the text of the digital document to identify strings of words in the text and, for each string of words, determining a relevancy score of the string of words, wherein: 1) the relevancy score defines a degree of relevancy of the string of words to the digital document, and 2) the string of words is defined as one of the plurality of key terms when the relevancy score of the string of words exceeds a threshold.

11. The computer implemented method of claim 1, wherein the digital document is a web page.

12. The computer implemented method of claim 11, further comprising receiving an address corresponding to the web location, wherein the web page is obtained from the web location.

13. The computer implemented method of claim 12, further comprising retrieving a plurality of related web pages to the web page, wherein at least one of the plurality of related web pages either links to the web page or is linked from the web page.

14. The computer implemented method of claim 13, further comprising determining additional key terms from the plurality of related web pages, wherein the plurality of key terms includes the additional key terms.

15. The computer implemented method of claim 1 further comprising receiving from the user terminal an indication that an advertiser has adopted the advertising structure as part of the on-line advertising campaign, such that an advertisement corresponding to the web location is provided for display to a user in response to receiving a search query by the user for at least one of the subset key terms.

16. A campaign building engine for generating an on-line advertising campaign for a web location, the campaign building engine including one or more processors and a computer readable medium storing instructions for generating the on-line advertising campaign, the instructions executable by the one or more processors, the campaign building engine comprising:
a document retrieving module that retrieves a digital document containing text, the digital document corresponding to the web location;
a key term determination module that determines a plurality of key terms from the text;
a classification module that determines a classification based on the plurality of key terms;
an advertising structure generation module that:
i) determines a correspondence between each of the key terms and the classification,
ii) associates a subset of the plurality of key terms with the classification based on the correspondence between each of the key terms of the plurality of key terms and the classification, and
iii) generates an advertising structure based on the subset of key terms and the web location; and
a user interface that provides the advertising structure for display at a user terminal.

17. The campaign building engine of claim 16, wherein the advertising structure generation module associates a first key term of the plurality of key terms to the classification when at least one word of the first key term matches at least one word of the classification.

18. The campaign building engine of claim 16, wherein the classification module determines an inverse document frequency score for each key term of the plurality of key terms and selects one of the key terms as the classification based on the inverse document frequency scores.

19. The campaign building engine of claim 18, wherein the advertising structure generation module assigns an overlapping key term to the classification when an affinity score of the classification to the subset of key terms is greater than an other affinity score of an other classification to an other subset of key terms, wherein 1) an overlapping key term belongs to the subset of key terms and the other subset of key terms, and 2) the affinity score of the classification indicates a measure of correspondence between the classification and the subset of key terms.

20. The campaign building engine of claim 19, wherein classification module determines the affinity score of the classification based on an amount of key terms in the subset of key terms associated to the classification and the inverse document frequency score of the key term selected as of the classification.

21. The campaign building engine of claim 20, wherein the advertising structure generation module calculates the affinity score of the classification by dividing the inverse document frequency score by the amount of key terms in the subset of key terms associated to the classification.

22. The campaign building engine of claim 19 wherein the advertising structure generation module assigns a nonoverlapping key term that belongs to the subset of key terms to the classification.

23. The campaign building engine of claim 18, wherein the classification module is further configured to generate a templated classification based on the determined classification, wherein: 1) the templated classification includes a tag substituted for at least one word of the key term selected as the classification is based, and 2) the tag defines a genus of a species of the at least one word being substituted.

24. The computer campaign building engine of claim 23, wherein the advertising structure generation modules associates a particular key word of the plurality of key words to the templated classification when at least one word of the particular key word is of a species that belongs to the genus of the tag of the templated classification.

25. The campaign building engine of claim 16, wherein the key term determination module parses the text of the digital document to identify strings of words in the text and, for each string of words, determines a relevancy score of the string of words, wherein: 1) the relevancy score defines a degree of relevancy of the string of words to the digital document, and 2) the string of words is defined as one of the plurality of key terms when the relevancy score of the string of words exceeds a threshold.

26. The campaign building engine of claim 16, wherein the digital document is a web page stored at a web server.

27. The campaign building engine of claim 26, wherein the document retrieving module receives an address corresponding to the web location and retrieves the web page from the web location.

28. The campaign building engine of claim 25, wherein the document retrieving module retrieves a plurality of related web pages from the web server, wherein at least a subset of the related web pages either link to the web page or are linked from the web page.

29. The campaign building engine of claim 28, wherein the key term determination module is further configured to determine additional key terms from the plurality of related web pages, wherein the plurality of key terms includes the additional key terms.
